(19) United States
(12) Patent Application Publication
(10) Pub. No.: US 2021/0370920 A1
(43) Pub. Date: Dec. 2, 2021

(54) VEHICLE PERIPHERY MONITORING DEVICE, CONTROL METHOD AND PROGRAM

(71) Applicant: TOYOTA JIDOSHA KABUSHIKI KAISHA, Toyota-shi (JP)

(72) Inventors: Atsutoshi SAKAGUCHI, Toyota-shi (JP); Tomohito HIGUMA, Toyota-shi (JP); Yohei SATOMI, Okazaki-shi (JP)

(21) Appl. No.: 17/319,280

(22) Filed: May 13, 2021

(30) Foreign Application Priority Data
May 27, 2020 (JP) 2020-092677

(51) Int. Cl. B60W 30/08; B60W 50/14; G06K 9/00; G06K 9/32

(52) U.S. Cl. CPC B60W 30/08; B60W 50/14; G06K 9/00791; B60W 2554/4048; B60W 2420/42; B60W 2554/4049; B60W 2050/146; G06K 9/3233

(57) ABSTRACT

A vehicle periphery monitoring device that: captures images of rear lateral sides and a rear side of a vehicle; detects objects that exist in, rear lateral overlap regions of captured rear lateral images, and rear overlap regions of a captured rear image; determines whether or not a specific object, which is seen only in either of the rear lateral overlap regions in the rear lateral images or the rear overlap regions in the rear image, is included among the detected objects; and, in a case in which it is determined that the specific object is included, displays a specific object display, which corresponds to the specific object, overlapping with the rear lateral image or the rear image, in which the specific object is not seen, on at least one display portion.

### CROSS-REFERENCE TO RELATED APPLICATION

This application is based on and claims priority under 35 USC 119 from Japanese Patent Application No. 2020-092677 filed on May 27, 2020, the disclosure of which is incorporated by reference herein.

### BACKGROUND

### Technical Field

The present disclosure relates to a vehicle periphery monitoring device, a control method and a program.

### Related Art

Japanese Patent Application Laid-Open (JP-A) No. 2020-028027 discloses an electronic mirror device that generates a first combined image by combining a rear image, which is captured by a rear camera that captures images of the vehicle rear side, and rear lateral images, which are captured by rear lateral cameras that capture images of the rear lateral sides of the vehicle, and displays the first combined image on a display portion that is provided within a vehicle cabin.

This electronic mirror device determines whether or not an object exists in the blind spot region that arises due to a rear following vehicle that is approaching from the rear of the vehicle. If an object does exist, a second combined image, in which the rear lateral image that includes the image region corresponding to the object is displayed overlappingly with the rear image, is generated. Then, the image that is displayed on the display portion is switched to the second combined image.

In the technique of JP-A No. 2020-028027, the first combined image is seen as an image in which the rear image and the rear lateral images are continuous. In contrast, in the second combined image, at the portions where the rear lateral images are displayed overlappingly on the rear image, the image angles of the rear image and the rear lateral images are different, and therefore, the image is displayed discontinuously. Accordingly, the way of looking even at the same object differs in a case in which the object is viewed in the first combined image and a case in which the object is viewed in the second combined image. Thus, there is the problem that this is troublesome for the vehicle occupant who is viewing the display portion.

### SUMMARY

In view of the above-described circumstances, an object of the present disclosure is to provide a vehicle periphery monitoring device that improves the visibility of a display portion, and enables an occupant of the vehicle to effectively recognize the situation at the periphery.

A vehicle periphery monitoring device relating to a first aspect of the present disclosure has: a rear lateral side imaging section that captures images of rear lateral sides of a vehicle; a rear imaging section that captures images of a rear side of the vehicle; a detecting section that detects objects that exist in, of rear lateral images captured by the rear lateral side imaging section, rear lateral overlap regions that overlap a rear image captured by the rear imaging section, and, of the rear image, rear overlap regions that overlap the rear lateral images; a determining section that determines whether or not a specific object, which is seen in only either the rear lateral overlap regions in the rear lateral images or the rear overlap regions in the rear image, is included among the objects detected by the detecting section; and a display control section that, in a case in which it is determined by the determining section that the specific object is included, displays a specific object display, which corresponds to the specific object, overlappingly with the rear lateral image or the rear image in which the specific object is not seen, on at least one display portion that is provided within a vehicle cabin.

In the first aspect, the rear lateral side imaging section captures images of the rear lateral sides of the vehicle, and the rear imaging section captures an image of the rear side of the vehicle. The display control section displays, on at least one display portion that is provided within the vehicle cabin, the rear lateral images that are captured by the rear lateral side imaging section and the rear image that is captured by the rear imaging section. Here, there are cases in which, in the rear lateral images, rear lateral overlap regions that overlap the rear image, and, in the rear image, rear overlap regions that overlap the rear lateral images are in blind spots in the rear lateral images or in the rear image due to another vehicle that is approaching from the rear side of the vehicle, or the like. With respect to this, the detecting section detects objects that exist in the rear lateral overlap regions and the rear overlap regions. Further, the determining section determines whether or not a specific object, which is recognized only in either of a rear lateral overlap region or a rear overlap region, is included among the objects detected by the detecting section. In a case in which it is determined by the determining section that a specific object is included, the display control section displays, on the display portion, a specific object display, which corresponds to the specific object, overlapping with the rear lateral image or the rear image, in which the specific object is not seen. Namely, among the objects that are detected by the detecting section, a specific object that is recognized only in either of a rear lateral overlap region or a rear overlap region, is an object that is blocked by another vehicle or the like that is approaching the rear side of the vehicle, and that exists in a region that is a blind spot in the rear lateral image or the rear image. Therefore, by superimposing a specific object display, which corresponds to the specific object, on the rear lateral image or the rear image, in which the specific object is not seen, and displaying the resulting image, the vehicle occupant can be made to recognize that the specific object exists at the rear of the another vehicle or the like that is approaching the rear of the vehicle. Further, the display control section overlappingly displays only the specific object display on the rear lateral image or the rear image, in which the specific object cannot be seen. Therefore, an image, in which a constant image angle is maintained, is displayed in the region, which is other than the specific object display, of the image displayed on the display portion. Thus, it is easy to recognize the specific object display within the image, and the driver overlooking or misidentifying the specific object display before or after the specific object display is displayed can be suppressed.

In this way, the ability of a vehicle occupant to see a specific object, which exists in a blind spot within a rear lateral image or a rear image due to another vehicle or the like that is approaching from the rear side of the vehicle, improves. As a result, the visibility of the object displayed on the display portion is improved, and the vehicle occupant can effectively be made to recognize the peripheral situation.

In a vehicle periphery monitoring device relating to a second aspect of the present disclosure, in the structure of the first aspect, in a case in which the specific object exists in a first blind spot region that is within the rear lateral image and arises due to a rear-lateral approaching vehicle that is approaching a rear lateral side of the vehicle, the display control section displays, on the display portion, the specific object display, which corresponds to the specific object seen in the rear image, overlappingly within the rear lateral image in which the specific object is not seen due to the rear-lateral approaching vehicle.

Due thereto, even in a case in which an object exists in a first blind spot region that is within a rear lateral image and that arises due to a rear-lateral approaching vehicle that is approaching a rear lateral side of the vehicle, by determining that this object is a specific object, the specific object can be displayed within the rear lateral image in the form of the specific object display. Due thereto, by looking at the specific object display, the vehicle occupant can know of the existence of the specific object in the vicinity of the rear of a rear-lateral approaching vehicle, and can definitively recognize the peripheral situation at the rear of the rear-lateral approaching vehicle.

In a vehicle periphery monitoring device relating to a third aspect of the present disclosure, in the structure of the first or second aspect, in a case in which the specific object exists in a second blind spot region that is within the rear image and arises due to a rear approaching vehicle that is approaching a rear of the vehicle, the display control section displays, on the display portion, the specific object display, which corresponds to the specific object seen in the rear lateral image, overlappingly within the rear image in which the specific object is not seen due to the rear approaching vehicle.

Due thereto, even in a case in which an object exists in a second blind spot region that is within the rear image and that arises due to a rear approaching vehicle that is approaching the rear of the vehicle, by determining that this object is a specific object, the specific object can be displayed within the rear image in the form of the specific object display. Due thereto, by looking at the specific object display, the vehicle occupant can know of the existence of the specific object in the rear of a rear approaching vehicle, and can definitively recognize the peripheral situation at the rear of the rear approaching vehicle.

In a vehicle periphery monitoring device relating to a fourth aspect of the present disclosure, in the structure of any one of the first through third aspects, the display control section deletes the rear lateral overlap regions or the rear overlap regions from either the rear lateral images or the rear image on a virtual projection plane, and carries out combining processing that combines the rear lateral images and the rear image, from either of which the rear lateral overlap regions or the rear overlap regions were deleted, into a single image, and displays the image on the one display portion.

Due thereto, the rear lateral processed images and the rear processed image that are displayed on the display portion become a continuous image, and an image that is close to a case of viewing the rear side of the vehicle can be displayed on the display portion. As a result, the burden on the vehicle occupant at the time of recognizing a specific object is reduced, and the visibility of the display portion improves.

In a vehicle periphery monitoring device relating to a fifth aspect of the present disclosure, in the structure of any one of the first through third aspects, the display control section displays the rear lateral images, which include the rear lateral overlap regions, and the rear image, which includes the rear overlap regions, which are on a virtual projection plane, onto plural display portions individually and respectively.

Due thereto, the vehicle occupant can see the rear lateral images, which include the rear lateral overlap regions, and the rear image, which includes the rear overlap regions, which are on a virtual projection plane, and thus, can recognize the peripheral situation at the rear side of the vehicle over a wide range. Further, because both the specific object and the specific object display corresponding thereto are displayed on the plural display portions, the position of the specific object can be recognized definitively from the plural display portions. As a result, the visibility of the display portions improves.

In a vehicle periphery monitoring device relating to a sixth aspect of the present disclosure, in the structure of any one of the first through fifth aspects, the display control section carries out overlapping display, on the display portion, of the specific object display on the rear lateral image or the rear image when the specific object is approaching the vehicle.

Due thereto, by carrying out displaying of the specific object display on the display portion at more dangerous times, i.e., at times when the specific object is approaching the vehicle, the vehicle occupant can effectively be warned to pay attention.

In the structure of any one of the first aspect through the sixth aspect, the vehicle periphery monitoring device may be an electronic mirror device that is installed in the vehicle, as in a seventh aspect for example.

The vehicle periphery monitoring device relating to the first aspect of the present disclosure has the excellent effects that the visibility of the display portion can be improved, and the vehicle occupant can effectively be made to recognize the peripheral situation.

The vehicle periphery monitoring device relating to the second aspect of the present disclosure has the excellent effect that the vehicle occupant can be made to definitively recognize the peripheral situation at the rear side of a rear-lateral approaching vehicle.

The vehicle periphery monitoring device relating to the third aspect of the present disclosure has the excellent effect that the vehicle occupant can be made to definitively recognize the peripheral situation at the rear side of a rear approaching vehicle.

The vehicle periphery monitoring device relating to the fourth aspect of the present disclosure has the excellent effects that the burden on the vehicle occupant at the time of recognizing the specific object can be reduced, and the visibility of the display portion can be improved.

The vehicle periphery monitoring device relating to the fifth aspect of the present disclosure has the excellent effects that the peripheral situation at the rear of the vehicle can be displayed over a wide range, and the visibility of the display portion can be improved due to the specific object display being displayed in a form that enables the position of the specific object to be recognized definitively.

The vehicle periphery monitoring device relating to the sixth aspect of the present disclosure has the excellent effect that the vehicle occupant can effectively be warned to pay attention to a specific object at the rear of the vehicle.

The vehicle periphery monitoring device relating to the seventh aspect of the present disclosure has the excellent effects that the visibility of the display portion of the electronic mirror device can be improved, and the vehicle occupant can effectively be made to recognize the peripheral situation.

### BRIEF DESCRIPTION OF THE DRAWINGS

Exemplary embodiments of the present invention will be described in detail based on the following figures, wherein:

FIG. 1 is a block drawing showing hardware structures of an electronic mirror device relating to a first embodiment;

FIG. 2 is a block drawing showing functional structures of the electronic mirror device relating to the first embodiment;

FIG. 3 is a drawing showing the placed positions of rear lateral cameras and a display portion of the electronic mirror device relating to the first embodiment, and is a perspective view in which the vehicle cabin interior of a vehicle that has the electronic mirror device is seen from the vehicle rear side;

FIG. 4 is a plan view showing imaging ranges of the rear lateral cameras and a rear camera, rear lateral overlap regions of the rear lateral images, and rear overlap regions of the rear image;

FIG. 5 is an image drawing showing an example of the state that is displayed on the display portion with rear lateral processed images and a rear processed image being combined into a single image;

FIG. 6 is a flowchart showing an example of superimposing processing that is executed by an electronic mirror ECU.

FIG. 7 is a plan view showing a first blind spot region that arises due to a rear-lateral approaching vehicle, and an example of a situation in which a specific object exists within the first blind spot region;

FIG. 8 is a plan view showing a second blind spot region that arises due to a rear approaching vehicle, and an example of a situation in which a specific object exists within the second blind spot region;

FIG. 9 is an image drawing showing an example of specific object display corresponding to the specific object that exists in the first blind spot region of FIG. 7;

FIG. 10 is an image drawing showing an example of specific object display corresponding to the specific object that exists in the second blind spot region of FIG. 8;

FIG. 11 is an image drawing that corresponds to FIG. 9 and shows an example of specific object display;

FIG. 12 is a block drawing showing hardware structures of an electronic mirror device relating to a second embodiment;

FIG. 13 is a block drawing showing functional structures of the electronic mirror device relating to the second embodiment;

FIG. 14 is an image drawing that corresponds to FIG. 9 and shows an example of specific object display corresponding to a specific object that exists in the first blind spot region; and

FIG. 15 is an image drawing that corresponds to FIG. 14 and shows an example of specific object display.

### DETAILED DESCRIPTION

(Hardware Structures)

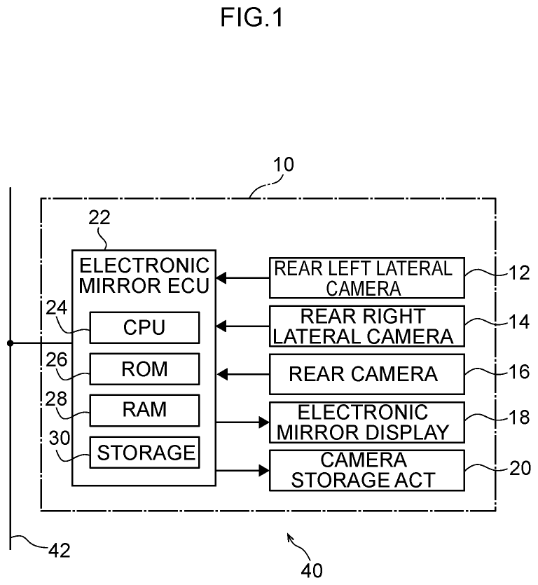

A first embodiment of the present invention is described hereinafter by using FIG. 1 through FIG. 11. An onboard system 40 shown in FIG. 1 includes a bus 42. Plural electronic control units, which carry out controls that differ from one another, and plural sensor units are respectively connected to the bus 42. Note that only the portions of the onboard system 40 that relate to the present invention are shown in FIG. 1. Each of the electronic control units is a control unit that includes a CPU, a memory, and a non-volatile storage, and hereinafter, these are called ECUs (Electronic Control Units). An electronic mirror ECU 22 is included among the plural ECUs that are connected to the bus 42.

A rear left lateral camera 12, a rear right lateral camera 14, a rear camera 16, an electronic mirror display 18 and a camera storage ACT (actuator) 20 are respectively connected to the electronic mirror ECU 22. The electronic mirror ECU 22, the rear left lateral camera 12, the rear right lateral camera 14, the rear camera 16, the electronic mirror display 18 and the camera storage ACT 20 structure an electronic mirror device 10, and the electronic mirror device 10 is an example of the vehicle periphery monitoring device. Note that, of the electronic mirror device 10, the electronic mirror display 18 is an example of the display portion.

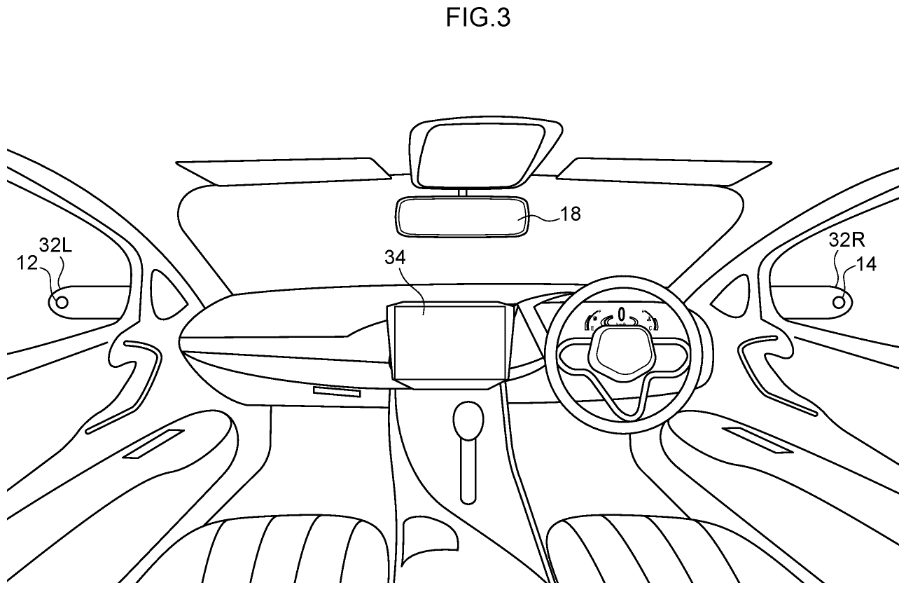

As shown in FIG. 3, the proximal portion of a camera supporting body 32L, which is substantially parallelepiped and whose distal end portion is arc-shaped, is mounted to the vehicle front side end portion of a vehicle vertical direction intermediate portion of a left side door (front side door, not illustrated) of the vehicle, such that the distal end portion of the camera supporting body 32L projects-out toward the vehicle outer side. The rear left lateral camera 12 is mounted to a vicinity of the distal end portion of the camera supporting body 32L. The imaging optical axis (lens) of the rear left lateral camera 12 faces toward the rear left side of the vehicle, and the rear left lateral camera 12 captures images of the rear left side of the vehicle. The camera supporting body 32L can rotate in the vehicle longitudinal direction. Due to the driving force of the camera storage ACT 20, the camera supporting body 32L is rotated to a stored position, at which the length direction of the camera supporting body 32L runs approximately along the outer side surface of the vehicle, or a returned position at which the rear left lateral camera 12 images the rear left side of the vehicle.

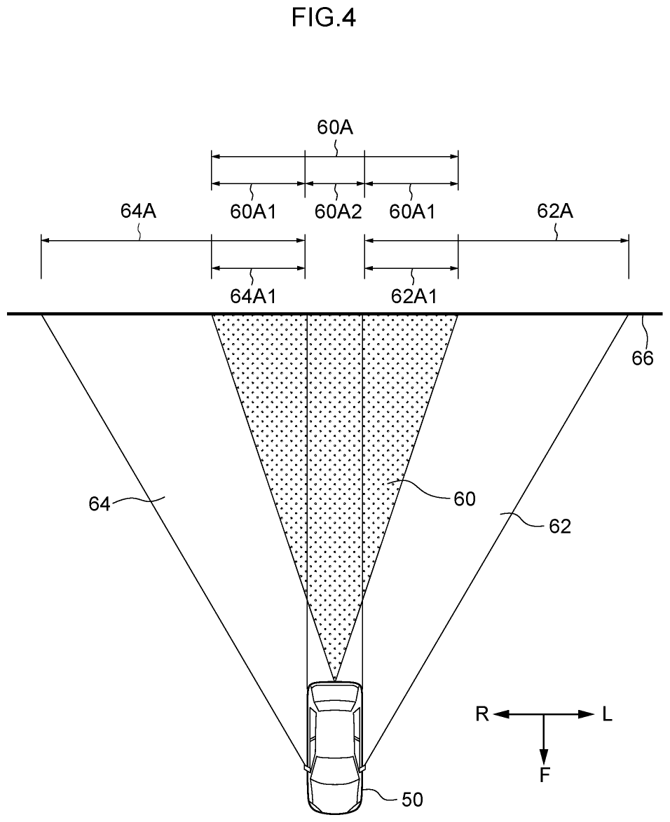

The lens of the rear left lateral camera 12 is a fixed focus lens, and a mechanism that changes the orientation of the imaging optical axis is not provided at the rear left lateral camera 12. In the state in which the camera supporting body 32L is positioned at the returned position, the rear left lateral camera 12 captures images of a fixed imaging range 62 that is shown in FIG. 4. Further, in the present embodiment, a rear lateral image 62A at the vehicle left side, which is projected on a virtual projection plane 66 at the rear of a vehicle 50, is the rear lateral image that is captured by the rear left lateral camera 12. Further, a portion of the imaging range 62 of the rear left lateral camera 12 overlaps with an imaging range 60 of the rear camera 16. Of the rear lateral image 62A, a rear lateral overlap region, which overlaps a rear image 60A of the rear camera 16 that is projected on the virtual projection plane 66, is shown as 62A1 in FIG. 4.

The proximal portion of a camera supporting body 32R, which has a shape that has left-right symmetry with respect to that of the camera supporting body 32L, is mounted to the vehicle front side end portion of a vehicle vertical direction intermediate portion of a right side door (front side door, not illustrated) of the vehicle. The rear right lateral camera 14 is mounted to a vicinity of the distal end portion of the camera supporting body 32R. The imaging optical axis (lens) of the rear right lateral camera 14 faces toward the rear right side of the vehicle, and the rear right lateral camera 14 captures images of the rear right side of the vehicle. The camera supporting body 32R also can rotate in the vehicle longitudinal direction. Due to the driving force of the camera storage ACT 20, the camera supporting body 32R is rotated to a stored position, at which the length direction of the camera supporting body 32R runs approximately along the outer side surface of the vehicle, or a returned position at which the rear right lateral camera 14 images the rear right side of the vehicle.

The lens of the rear right lateral camera 14 is a fixed focus lens, and a mechanism that changes the orientation of the imaging optical axis is not provided at the rear right lateral camera 14. In the state in which the camera supporting body 32R is positioned at the returned position, the rear right lateral camera 14 captures images of a fixed imaging range 64 that is shown in FIG. 4. Further, in the present embodiment, a rear lateral image 64A at the vehicle right side, which is projected on the virtual projection plane 66 at the rear of the vehicle 50, is the rear lateral image that is captured by the rear right lateral camera 14. Further, a portion of the imaging range 64 of the rear right lateral camera 14 overlaps with the imaging range 60 of the rear camera 16. Of the rear lateral image 64A, a rear lateral overlap region, which overlaps the rear image 60A of the rear camera 16 that is projected on the virtual projection plane 66, is shown as 64A1 in FIG. 4.

The rear camera 16 is disposed at the rear portion of the vehicle 50 (see FIG. 4), and the imaging optical axis (lens) thereof faces toward the rear side of the vehicle, and the rear camera 16 captures images of the rear side of the vehicle 50. Note that it suffices for the disposed position of the rear camera 16 to be a position at which the rear camera 16 can capture images of the rear side of the vehicle 50, and the rear camera 16 may be disposed at the rear end portion of the vehicle 50 (e.g., in a vicinity of the rear bumper), or may be disposed so as to capture images of the rear side of the vehicle 50 through the rear windshield glass. The lens of the rear camera 16 is a fixed focus lens, and a mechanism that changes the orientation of the imaging optical axis is not provided at the rear camera 16. The rear camera 16 captures images of the fixed imaging range 60 that is shown in FIG. 4. In the present embodiment, the rear image 60A at the center, which is projected on the virtual projection plane 66 at the rear of the vehicle 50, is the rear image that is captured by the rear camera 16. Further, of the rear image 60A, the regions, which overlap the rear lateral image 62A at the vehicle left side and the rear lateral image 64A at the vehicle right side that are projected on the virtual projection plane 66, are shown as rear overlap regions 60A1 in FIG. 4.

A central monitor 34 is provided at the central portion of the instrument panel of the vehicle, and the electronic mirror display 18 is provided at a position that is apart, toward the vehicle upper side, from the central monitor 34. Due to the electronic mirror ECU 22, the electronic mirror display 18 carries out combining processing that is described hereafter on the rear left lateral image (video image) captured by the rear left lateral camera 12, the rear right lateral image (video image) captured by the rear right lateral camera 14, and the rear image (video image) captured by the rear camera 16, and the combined image is displayed.

As shown in FIG. 1, the electronic mirror ECU 22 includes a CPU (Central Processing Unit) 24, a ROM (Read Only Memory) 26, a RAM (Random Access Memory) 28, and a storage 30.

The CPU 24 is a central computing processing unit, and executes various programs and controls various sections. Namely, the CPU 24 reads-out programs from the ROM 26 or the storage 30, and executes the programs by using the RAM 28 as a workspace.

(Functional Structures)

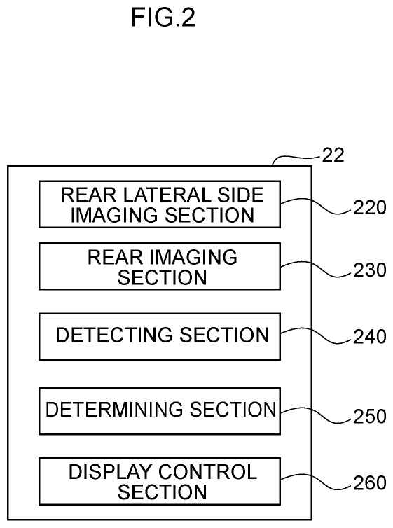

FIG. 2 is a block drawing showing the functional structures of the electronic mirror ECU 22. As shown in this drawing, the electronic mirror ECU 22 has a rear lateral side imaging section 220, a rear imaging section 230, a detecting section 240, a determining section 250, and a display control section 260. These respective functional structures are realized by execution programs that are stored in the ROM 26 or the storage 30 being read-out and being executed.

The rear lateral side imaging section 220 captures, by video images, images of the left and right rear lateral sides of the vehicle 50 by the rear left lateral camera 12 and the rear right lateral camera 14, and outputs the captured rear lateral images to the detecting section 240 and the display control section 260.

The rear imaging section 230 captures, by video images, images of the rear side of the vehicle 50 by the rear camera 16, and outputs the captured rear images to the detecting section 240 and the display control section 260.

The detecting section 240 analyzes the rear lateral images 62A, 64A and the rear image 60A, and detects objects that exist in, of the rear lateral images 62A, 64A, the rear lateral overlap regions 62A1, 64A1 that overlap with the rear image 60A, and, of the rear image 60A, the left and right rear overlap regions 60A1 that overlap with the rear lateral images 62A, 64A. Then, the detecting section 240 outputs information relating to the detected objects to the determining section 250. Note that the detecting section 240 may be structured so as to detect objects existing in regions corresponding to the rear lateral overlap regions 62A1, 64A1 and the rear overlap regions 60A1, on the basis of the results of detection of a radar whose detection range is the rear side of the vehicle 50, or the like.

On the basis of the information relating to the objects that was outputted from the detecting section 240, the determining section 250 determines whether or not, among the objects that exist in the rear lateral overlap regions 62A1, 64A1 and the rear overlap regions 60A1, there is included a specific object that is recognized only in either of the rear lateral overlap regions 62A1, 64A1 or the rear overlap regions 60A1. The determining section 250 carries out this determination by, for example, analyzing the rear lateral images 62A, 64A and the rear image 60A, and contrasting the objects that are detected in the rear lateral images 62A, 64A and the objects that are detected in the rear image 60A.

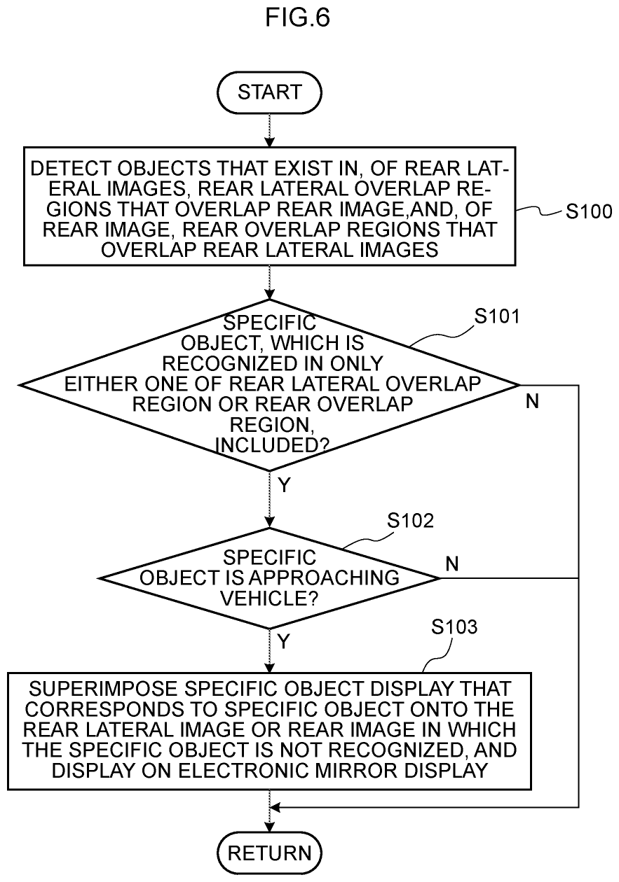

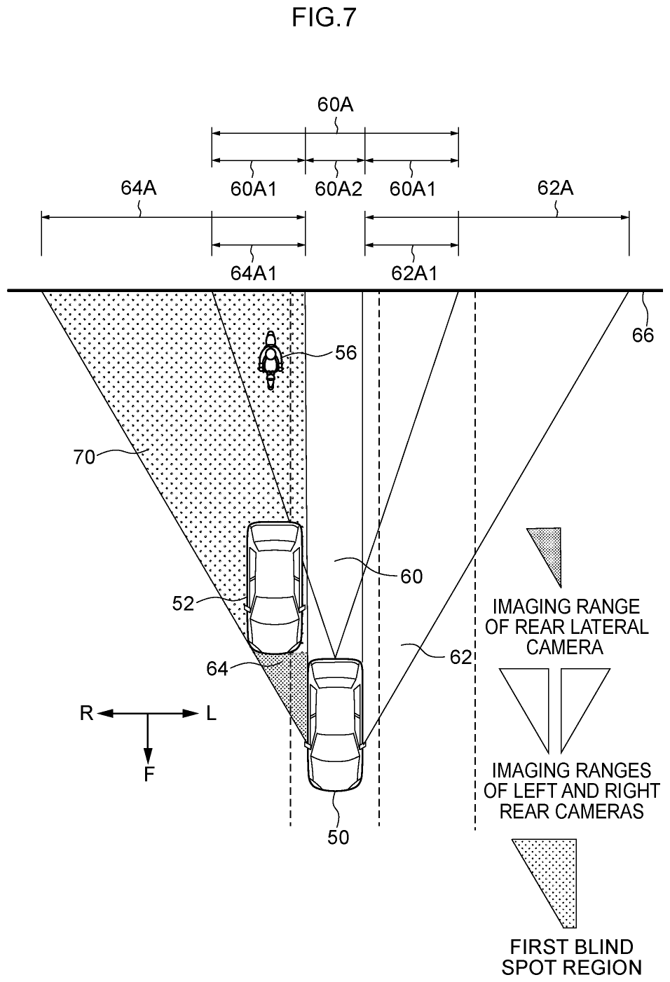

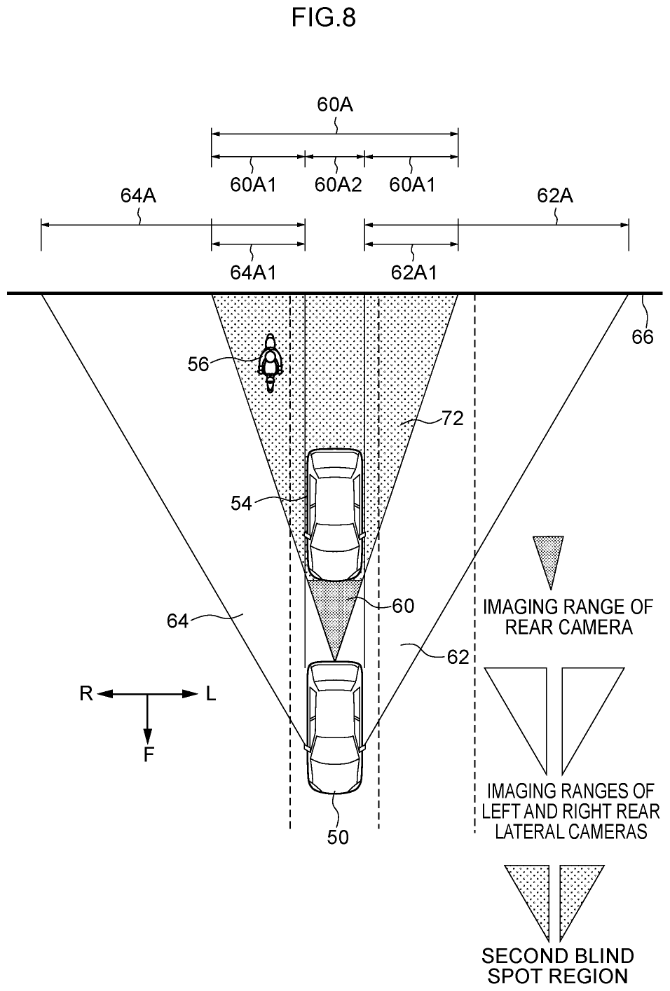

The display control section 260 has the functions of generating an image obtained by subjecting the rear lateral images 62A, 64A and the rear image 60A, which were outputted from the rear lateral side imaging section 220 and the rear imaging section 230, to combining processing, and displaying the generated image on the electronic mirror display 18. In a case in which a rear-lateral approaching vehicle 52 (see FIG. 7) that is approaching a rear lateral side of the vehicle 50 or a rear approaching vehicle 54 (see FIG. 8) that is approaching the rear side of the vehicle 50 is detected, a superimposing processing (see FIG. 6) that displays a specific marker display overlappingly with the rear lateral images and the rear image, is included as a subroutine in this combining processing routine.

(Operation and Effects)

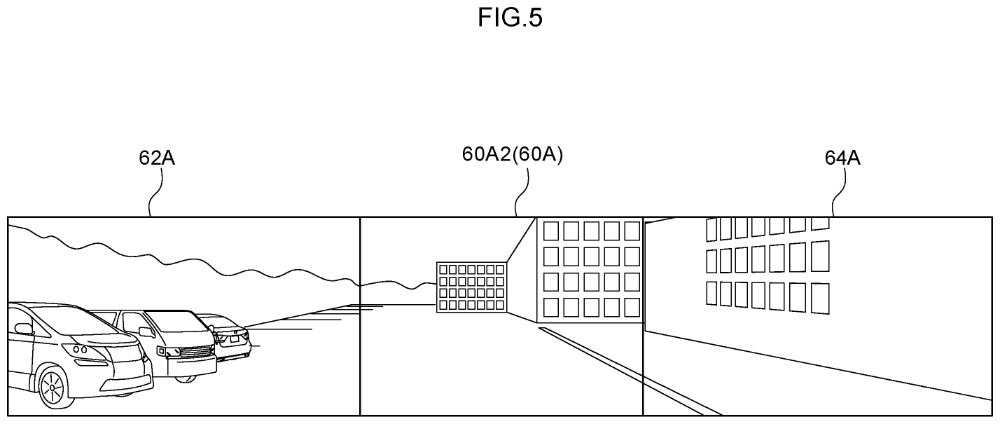

Operation of the first embodiment is described next. Further, the combining processing, which causes the electronic mirror ECU 22 to display, on the electronic mirror display 18, the rear lateral images captured by the rear left and right lateral cameras 12, 14 and the rear image captured by the rear camera 16, is described next by using FIG. 4 and FIG. 5. To explain this combining processing concretely, the electronic mirror ECU 22 extracts the rear lateral images 62A, 64A that have been captured by the rear left lateral camera 12 and the rear right lateral camera 14 and that are on the virtual projection plane 66.

In the next step, the electronic mirror ECU 22 extracts an image of region 60A2 that is obtained by deleting the left and right rear overlap regions 60A1 from the rear image 60A that was captured by the rear camera 16 and is on the virtual projection plane 66.

In the next step, the electronic mirror ECU 22 combines the rear lateral image 62A with the left side of the extracted region 60A2, and combines the rear lateral image 64A with the right side of the extracted region 60A2, and generates a single image.

In the next step, the electronic mirror ECU 22 causes the electronic mirror display 18 to display the rear lateral images 62A, 64A and the extracted region 60A2 that have been combined into a single image. An example of the image displayed on the electronic mirror display 18 by the above-described combining processing is shown in FIG. 5.

As shown in FIG. 5, the image that is displayed on the electronic mirror display 18 is generated by deleting the left and right rear overlap regions 60A1 from the rear image 60A on the virtual projection plane 66 so as to generate the image of the extracted region 60A2, and carrying out combining processing that combines the rear lateral images and the rear image into a single image. Due thereto, the rear lateral images and the rear image that are displayed on the electronic mirror display 18 become a smooth, continuous image, and an image that is close to a case of viewing the rear side of the vehicle 50 can be displayed on the electronic mirror display 18. As a result, the burden on the vehicle occupant at the time of recognizing a specific object that is described later is reduced, and the visibility of the electronic mirror display 18 improves.

In the next step, the electronic mirror ECU 22 determines whether or not there exists the rear-lateral approaching vehicle 52 (see FIG. 7) that is approaching a rear lateral side of the vehicle 50, or the rear approaching vehicle 54 (see FIG. 8) that is approaching the rear of the vehicle 50. Note that the rear-lateral approaching vehicle 52 and the rear approaching vehicle 54 can be detected by, for example, analysis of the rear lateral images 62A, 64A and the rear image 60A, and it can be determined whether or not the rear-lateral approaching vehicle 52 or the rear approaching vehicle 54 exists at a relatively close distance, on the basis of whether or not the size of the image region, which corresponds to the rear-lateral approaching vehicle 52 or the rear approaching vehicle 54 that is included in the rear lateral images 62A, 64A or the rear image 60A, is greater than or equal to a predetermined value. Further, the determination on the absence/presence of the rear-lateral approaching vehicle 52 or the rear approaching vehicle 54 can also be a determination that is based on, for example, the results of detection of a radar whose detection range is the rear side of the vehicle 50, or the like. In this case, the distance between the vehicle 50 and the rear-lateral approaching vehicle 52 or the rear approaching vehicle 54 can be determined more accurately.

If the above-described determination is negative, i.e., if neither the rear-lateral approaching vehicle 52 nor the rear approaching vehicle 54 exists, the routine returns to the start of the combining processing step, and the above-described steps are repeated. During this time, the generating/displaying of the single image obtained by combining the rear lateral images and the rear image is continued.

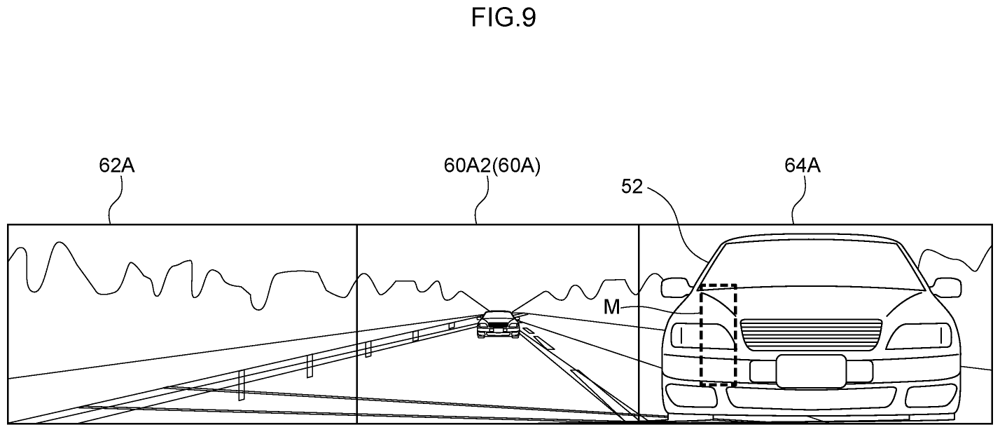

On the other hand, as shown as an example in FIG. 7, if the rear-lateral approaching vehicle 52 does exist at the rear right lateral side of the vehicle 50, the determination of the above-described step is affirmative, and superimposing processing that is included as a sub-routine in the above-described combining processing is executed (see FIG. 6). As shown in FIG. 7, if the rear-lateral approaching vehicle 52 is traveling at the rear right lateral side of the vehicle 50, a first blind spot region 70 arises within the rear lateral image 64A of the rear right lateral camera 14 due to this rear-lateral approaching vehicle 52. The rear lateral overlap region 64A1 of the rear right lateral camera 14 is included in this first blind spot region 70. Accordingly, if a motorcycle 56 exists in the rear lateral overlap region 64A1 of the rear right lateral camera 14, the motorcycle 56 is blocked by the rear-lateral approaching vehicle 52, and will not appear in the rear lateral image of the electronic mirror display 18 (see FIG. 9). Due thereto, there is the concern that the existence of the motorcycle 56 will not be recognized by the vehicle occupant who is looking at the electronic mirror display 18. Thus, if, for example, the vehicle 50 starts changing lanes into the lane at the right side and behind the rear-lateral approaching vehicle 52, the danger of contacting the motorcycle 56 increases. Therefore, in the superimposing processing that is described hereinafter, an image, in which a specific object display M that corresponds to the motorcycle 56 is displayed overlappingly in a rear lateral image, is generated/displayed as described later.

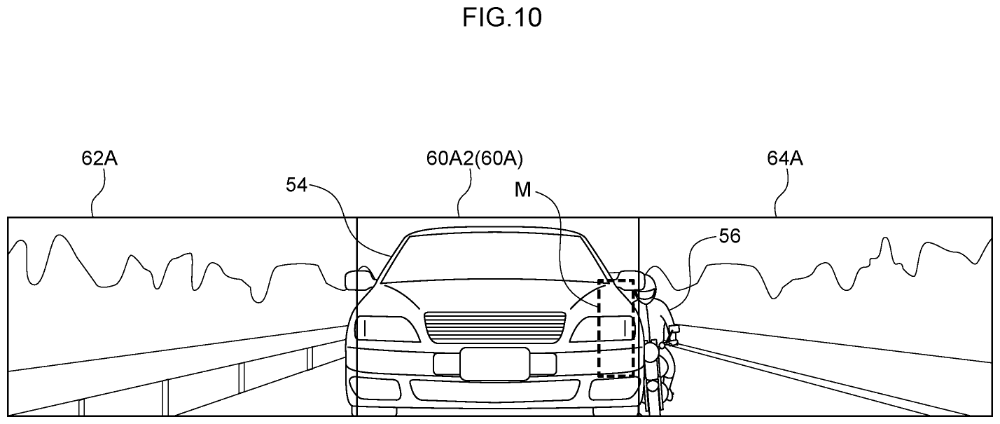

Further, as an example, if a rear approaching vehicle 54 exists at the rear of the vehicle 50 as shown in FIG. 8, the judgement of the above-described step is affirmative, and the superimposing processing is similarly executed. As shown in FIG. 8, if the rear approaching vehicle 54 is traveling at the rear of the vehicle 50, a second blind spot region 72 is formed within the rear image 60A of the rear camera 16 due to the rear approaching vehicle 54. The rear overlap regions 60A1 of the rear camera 16 are included in this second blind spot region 72. Accordingly, if the motorcycle 56 exists in the rear overlap region 60A1 that is at the right side of the vehicle 50, the motorcycle 56 is not seen in the rear image of the electronic mirror display 18 due to the rear approaching vehicle 54, and there are cases in which, in the rear lateral image, the motorcycle 56 is seen in a state of being partially blocked by the rear approaching vehicle 54 (see FIG. 10). Due thereto, there is the concern that the existence of the motorcycle 56 will not be recognized by the vehicle occupant who is looking at the electronic mirror display 18. Thus, if the vehicle 50 starts changing lanes into the lane at the right side, the danger of contacting the motorcycle 56 increases. Therefore, an image, in which the specific object display M that corresponds to the motorcycle 56 is displayed overlappingly in the rear image, is generated/displayed by the superimposing processing.

Concretely, as shown in FIG. 6, in step S100, the electronic mirror ECU 22 detects objects that exist in the rear lateral overlap regions 62A1, 64A1 of the left and right rear lateral images 62A, 64A, and in the left and right rear overlap regions 60A1 of the rear image 60A.

In next step S101, the electronic mirror ECU 22 determines whether or not a specific object, which can be seen only in either of the rear lateral overlap region 62A1 or the rear overlap region 60A1 at the left side of the vehicle 50, or a specific object, which can only be seen in either of the rear lateral overlap region 64A1 or the rear overlap region 60A1 at the right side of the vehicle 50, is included among the objects that were detected in the rear lateral overlap regions 62A1, 64A1 and the rear overlap regions 60A1. If the determination of step S101 is affirmative, the routine moves on to step S102. If the determination of step S101 is negative, the superimposing processing ends, and the routine returns to the steps of the combining processing.

As an example, in a case in which the rear-lateral approaching vehicle 52 is traveling at the rear lateral side at the right side of the vehicle 50 as shown in above-described FIG. 7, the motorcycle 56 exists in the first blind spot region 70 that arises due to the rear-lateral approaching vehicle 52, and therefore, the motorcycle 56 cannot be seen in the rear lateral image 64A that is captured by the rear right lateral camera 14. Accordingly, in step S100, from the image recognition of the rear lateral image 64A and the rear image 60A, the existence of an object (the motorcycle 56) is not detected (seen) in the rear lateral overlap region 64A1 that corresponds to the rear right lateral camera 14 of the vehicle 50, and, on the other hand, the motorcycle 56 is detected (seen) as an object in the rear overlap region 60A1 at the right side that corresponds to the rear camera 16. Then, in next step S101, the motorcycle 56 that was detected in step S100 is made to be a specific object that is seen in only one of the rear overlap regions 60A1. Accordingly, in step S101, the electronic mirror ECU 22 determines that a specific object (the motorcycle 56) is included among the objects detected in step S100 (only the motorcycle 56 in the example of FIG. 7).

Further, as in FIG. 8, in a case in which the rear approaching vehicle 54 is traveling at the rear of the vehicle 50, the motorcycle 56 exists in the second blind spot region 72 that arises due to the rear approaching vehicle 54, and therefore, the motorcycle 56 cannot be seen in the rear image 60A of the rear camera 16. Accordingly, in step S100, from the image recognition of the rear lateral image 64A that corresponds to the rear right lateral camera 14 and the rear image 60A, the existence of an object (the motorcycle 56) is detected (seen) in the rear lateral overlap region 64A1, and, on the other hand, the existence of an object is not detected (seen) in the rear overlap region 60A1. Then, in next step S101, the motorcycle 56 that was detected in step S100 is made to be a specific object that is seen in only the one rear lateral overlap region 64A1. Accordingly, in step S101, the electronic mirror ECU 22 determines that a specific object (the motorcycle 56) is included among the objects detected in step S100 (only the motorcycle 56 in the example of FIG. 9).

In step S102, the electronic mirror ECU 22 determines whether or not the specific object is approaching the vehicle 50. The determination of step S102 can be realized by determining whether or not a region that corresponds to the specific object (the motorcycle 56 in FIG. 7 and FIG. 8) exists in the rear lateral image 62A, 64A or the rear image 60A in which the specific object was recognized, and whether or not the size of this region is becoming larger as time passes. Note that this can be determined also on the basis of the results of detection of a radar whose detection range is a range that includes the rear lateral sides of the vehicle 50, or the like.

If the judgement of step S102 is affirmative, the routine moves on to step S103. If the determination of step S102 is negative, the superimposing processing ends, and the routine returns to the steps of the combining processing. In step S103, the electronic mirror ECU 22 displays, on the electronic mirror display 18, a specific object display, which corresponds to the specific object, overlappingly on the rear lateral image or the rear image in which the specific object was not seen.

As an example, in the situation shown in FIG. 7, the electronic mirror ECU 22 generates an image in which the specific object display M, which corresponds to the motorcycle 56 that is seen in the rear overlap region 60A1 at the right side, is displayed overlappingly on the rear lateral image 64A that corresponds to the rear right lateral camera 14 and in which the motorcycle 56 that is the specific object cannot be seen. Then, as shown in FIG. 9, the electronic mirror ECU 22 displays the generated rear lateral image on the electronic mirror display 18. For example, the specific object display M is displayed as an enclosing line that surrounds the specific object (the motorcycle 56).

The specific object display M is displayed overlappingly on the rear-lateral approaching vehicle 52 that appears in the rear lateral image 64A. Due thereto, the vehicle occupant who views the electronic mirror display 18 can recognize that the motorcycle 56 exists at the rear side of the rear-lateral approaching vehicle 52.

On the other hand, in the case of the situation shown in FIG. 8, the electronic mirror ECU 22 generates an image in which the specific object display M, which corresponds to the motorcycle 56 that is seen in the rear lateral overlap region 64A1 of the rear lateral camera 14 at the right side, is displayed overlappingly on the rear image 60A that corresponds to the rear camera 16 and in which the motorcycle 56 that is the specific object cannot be seen. Then, as shown in FIG. 10, the electronic mirror ECU 22 displays the generated rear image on the electronic mirror display 18.

The specific object display M is displayed overlappingly on the rear approaching vehicle 54 that appears in the rear processed image. Due thereto, the vehicle occupant who views the electronic mirror display 18 can recognize the existence of the motorcycle 56 that is approaching a rear lateral side of the rear approaching vehicle 54.

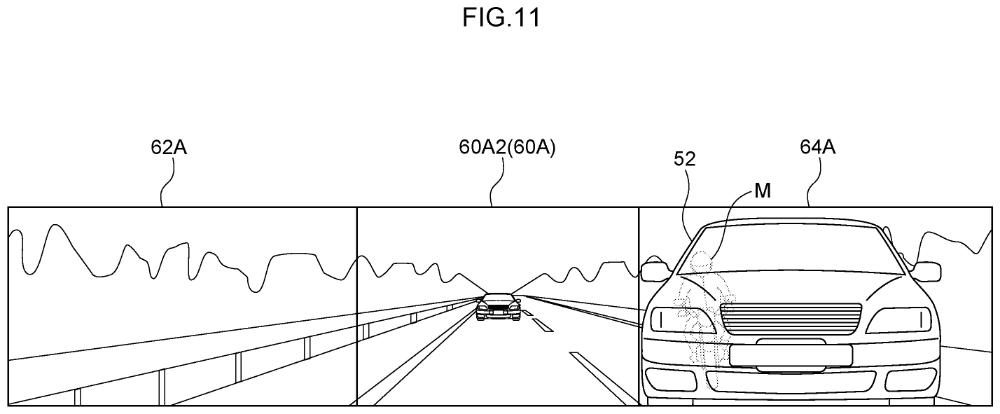

Note that the specific object display M may be a predetermined icon. Or, there may be a structure in which the displayed specific object display flashes on-and-off, and the frequency of the flashing increases as the distance between the specific object and the vehicle 50 decreases. Or, as in the example shown in FIG. 11, the image of the portion corresponding to the specific object (the motorcycle 56) that is recognized in the rear lateral image 62A, 64A or the rear image 60A may be extracted, and made to be the specific object display M. Or, the image that structures the specific object display M may be generated as a see-through image whose visibility is lower than that of the other images displayed on the electronic mirror display 18.

### Second Embodiment

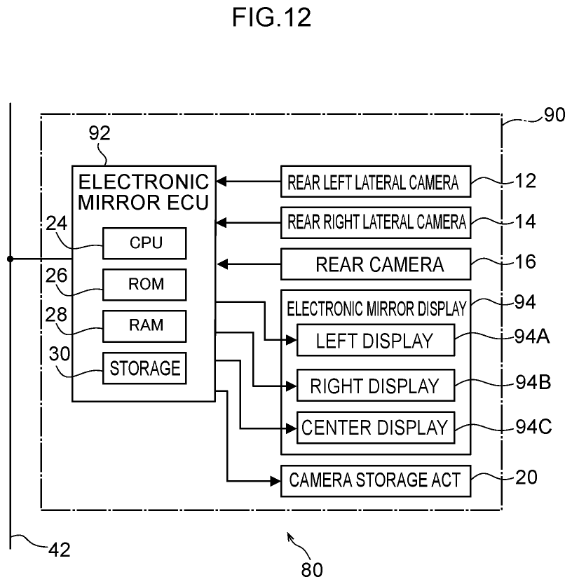

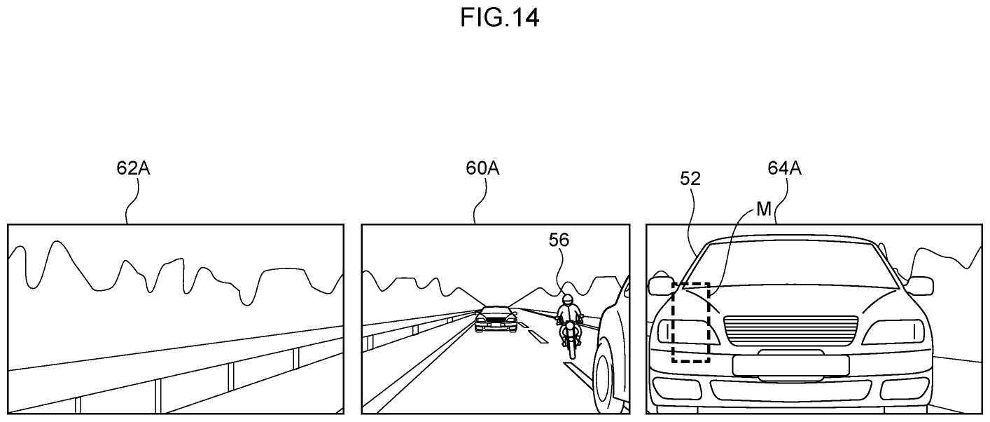

A second embodiment of the present invention is described hereinafter by using FIG. 12 through FIG. 15. Note that structural portions that are the same as those of the above-described first embodiment are denoted by the same reference numerals, and description thereof is omitted. The basic structure of an onboard system 80 relating to this second embodiment is similar to the first embodiment. However, the onboard system 80 has a feature in the point that the rear lateral images and the rear image that are captured by the rear left lateral camera 12, the rear right lateral camera 14 and the rear camera 16 are individually displayed on plural display portions (see FIG. 14).

(Hardware Structures)

Namely, the onboard system 80 has an electronic mirror device 90 that is structured by an electronic mirror ECU 92, the rear left lateral camera 12, the rear right lateral camera 14, the rear camera 16, an electronic mirror display 94, and the camera storage ACT 20. The electronic mirror display 94 that serves as the display portion has a left display 94A, a right display 94B and a center display 94C. The left display 94A displays the image captured by the rear left lateral camera 12. The right display 94B displays the image captured by the rear right lateral camera 14. The center display 94C displays the image captured by the rear camera 16.

(Functional Structures)

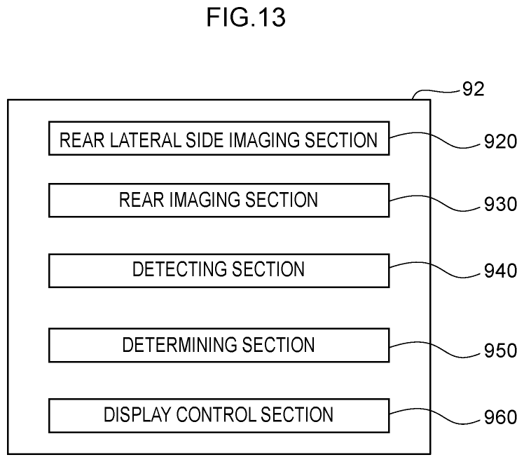

FIG. 13 is a block drawing showing the functional structures of the electronic mirror ECU 92. A display control section 960 extracts the left and right rear lateral images 62A, 64A that are on the virtual projection plane 66 shown in FIG. 4, and displays them on the left display 94A and the right display 94B, respectively. Namely, the display control section 960 displays the rear lateral images 62A, 64A, which include the rear lateral overlap regions 62A1, 64A1, as rear lateral images on the electronic mirror display 94.

Further, the display control section 960 extracts the rear image 60A that is on the virtual projection plane 66 shown in FIG. 4, and displays the rear image 60A on the center display 94C. Namely, the display control section 960 displays the rear image 60A, which includes the rear overlap regions 60A1, as a rear image on the electronic mirror display 94.

Further, in the same way as the display control section 260 of the above-described first embodiment, the display control section 960 executes the superimposing processing shown in FIG. 6. Note that a rear lateral side imaging section 920, a rear imaging section 930, a detecting section 940, and a determining section 950 have functions that are similar to those of the rear lateral side imaging section 220, the rear imaging section 230, the detecting section 240 and the determining section 250 of the first embodiment, and therefore, description thereof is omitted.

(Operation and Effects)

The electronic mirror device 90 of the above-described structure is structured similarly to the electronic mirror device 10 of the first embodiment, other than the point that the rear lateral processed images and the rear image are displayed individually, and therefore, effects that are similar to those of the first embodiment are obtained.

Further, as shown in FIG. 14, the vehicle occupant who is within the vehicle cabin can see the rear lateral images 62A, 64A, which include the left and right rear lateral overlap regions 62A1, 64A1 on the virtual projection plane 66, and the rear image 60A, which includes the left and right rear overlap regions 60A1 on the virtual projection plane 66. Therefore, the vehicle occupant who looks at the electronic mirror display 94 can recognize the peripheral situation at the rear of the vehicle over a wide range. Note that the image drawing of FIG. 14 is the rear lateral images and the rear image that are displayed on the electronic mirror display 94 in the situation shown in FIG. 7 as an example.

Further, in the present embodiment, both the specific object (the motorcycle 56) and the specific object display M corresponding thereto are displayed on the electronic mirror display 94 that is structured by the left display 94A, the right display 94B and the center display 94C. Therefore, the position of the specific object can be recognized definitively by viewing the image of the specific object and the specific object display M on the plural displays. As a result, the visibility of the electronic mirror display 94 improves.

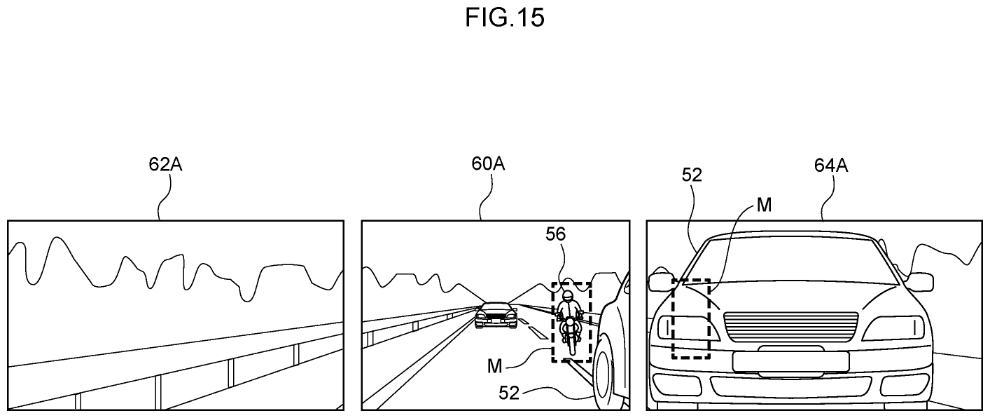

Note that, in a case in which both the specific object (the motorcycle 56) and the specific object display M corresponding thereto are displayed on the electronic mirror display 94 as in the present embodiment, as in the example shown in FIG. 15, a display that is similar to the specific object display M may be overlappingly displayed on the image of the specific object (the motorcycle 56). Due thereto, even in a case in which the specific object and the specific object display are displayed on respectively different displays, the vehicle occupant can quickly recognize that this is information relating to the same object, by looking at displays that are similar.

In the above-described first embodiment, there is a structure in which the rear lateral image 62A of the rear left lateral camera 12 and the rear lateral image 64A of the rear right lateral camera 14, which are on the virtual projection plane 66, are displayed on the electronic mirror display 18 as the rear lateral images of the present invention, and the extracted region 60A2, which is obtained by deleting the left and right rear overlap regions 60A1 from the rear image 60A of the rear camera 16, is displayed on the electronic mirror display 18 as the rear image of the present invention. However, the present invention is not limited to this, and may be structured such that images, which are extracted by deleting the rear lateral overlap regions 62A1, 64A1 from the rear lateral images 62A, 64A, are displayed on the electronic mirror display 18 as the rear lateral images of the present invention, and the rear image 60A that is on the virtual projection plane 66 is displayed on the electronic mirror display 18 as the rear image of the present invention.

What is claimed is:

1. A vehicle periphery monitoring device comprising:
a memory; and
a processor that is coupled to the memory,
wherein the processor:
captures images of rear lateral sides of a vehicle;
captures images of a rear side of the vehicle;
detects objects that exist in, of captured rear lateral images, rear lateral overlap regions having captured ranges that overlap a captured rear image, and, of the rear image, rear overlap regions having captured ranges that overlap the rear lateral images;
determines whether or not a specific object, which is seen only in either of the rear lateral overlap regions in the rear lateral images or the rear overlap regions in the rear image, is included among the detected objects; and
in a case in which it is determined that the specific object is included, displays a specific object display, which corresponds to the specific object, overlapping with the rear lateral image or the rear image, in which the specific object is not seen, on at least one display portion that is provided within a vehicle cabin.

2. The vehicle periphery monitoring device of claim 1, wherein:
in a case in which the specific object exists in a first blind spot region that is within the rear lateral image and arises due to a rear-lateral approaching vehicle that is approaching a rear lateral side of the vehicle, the processor displays, on the display portion, the specific object display, which corresponds to the specific object seen in the rear image, overlapping within the rear lateral image in which the specific object is not seen due to the rear-lateral approaching vehicle.

3. The vehicle periphery monitoring device of claim 1, wherein:
in a case in which the specific object exists in a second blind spot region that is within the rear image and arises due to a rear approaching vehicle that is approaching a rear of the vehicle, the processor displays, on the display portion, the specific object display, which corresponds to the specific object seen in the rear lateral image, overlapping within the rear image in which the specific object is not seen due to the rear approaching vehicle.

4. The vehicle periphery monitoring device of claim 1, wherein the processor deletes the rear lateral overlap regions of the rear lateral images or the rear overlap regions of the rear image, on a virtual projection plane, and carries out combining processing that combines the rear lateral images and the rear image into a single image, and displays the image on the one display portion.

5. The vehicle periphery monitoring device of claim 1, wherein the processor displays the rear lateral images, which include the rear lateral overlap regions, and the rear image, which includes the rear overlap regions, which are on a virtual projection plane, onto a plurality of display portions individually and respectively.

6. The vehicle periphery monitoring device of claim 5, wherein, in a case in which the rear lateral images and the rear image are individually and respectively displayed on the plurality of display portions, the processor displays the specific object display in both an image in which the specific object can be seen and an image in which the specific object is not seen.

7. The vehicle periphery monitoring device of claim 1, wherein, in a case in which the specific object display is displayed on the display portion, the processor causes the specific object display to flash on-and-off, and varies a flashing period in accordance with a distance between the vehicle and the specific object.

8. The vehicle periphery monitoring device of claim 1, wherein, in a case in which the specific object display is displayed on the display portion, the processor displays the specific object display as a see-through image having visibility that is lower than that of other images displayed on the display portion.

9. The vehicle periphery monitoring device of claim 1, wherein the processor carries out overlapping display, on the display portion, of the specific object display on the rear lateral image or the rear image in a case in which the specific object is approaching the vehicle.

10. The vehicle periphery monitoring device of claim 1, wherein the vehicle periphery monitoring device is an electronic mirror device that is installed at the vehicle.

11. A control method comprising:
capturing images of rear lateral sides of a vehicle;
capturing images of a rear side of the vehicle;
detecting objects that exist in, of captured rear lateral images, rear lateral overlap regions having captured ranges that overlap a captured rear image, and, of the rear image, rear overlap regions having captured ranges that overlap the rear lateral images;
determining whether or not a specific object, which is seen only in either of the rear lateral overlap regions in the rear lateral images or the rear overlap regions in the rear image, is included among the detected objects; and
in a case in which it is determined that the specific object is included, displaying a specific object display, which corresponds to the specific object, overlapping with the rear lateral image or the rear image, in which the specific object is not seen, on at least one display portion that is provided within a vehicle cabin.

12. A program that causes a computer to execute processings of:
capturing images of rear lateral sides of a vehicle;
capturing images of a rear side of the vehicle;
detecting objects that exist in, of captured rear lateral images, rear lateral overlap regions having captured ranges that overlap a captured rear image, and, of the rear image, rear overlap regions having captured ranges that overlap the rear lateral images;
determining whether or not a specific object, which is seen only in either of the rear lateral overlap regions in the rear lateral images or the rear overlap regions in the rear image, is included among the detected objects; and
in a case in which it is determined that the specific object is included, displaying a specific object display, which corresponds to the specific object, overlapping with the rear lateral image or the rear image, in which the specific object is not seen, on at least one display portion that is provided within a vehicle cabin.
